(19) United States
(12) Patent Application Publication
(10) Pub. No.: US 2014/0260645 A1
(43) Pub. Date: Sep. 18, 2014

(54) Differential Sensor Assembly With Both Pressures Applied From One Side

(71) Applicant: Kulite Semiconductor Products, Inc., Leonia, NJ (US)

(72) Inventors: Scott Goodman, Wayne, NJ (US); Joseph R. VandeWeert, Maywood, NJ (US); Alexander A. Ned, Kinnelon, NJ (US)

(73) Assignee: Kulite Semiconductor Products, Inc., Leonia, NJ (US)

(21) Appl. No.: 13/926,577

(22) Filed: Jun. 25, 2013

Related U.S. Application Data
(60) Provisional application No. 61/787,574, filed on Mar. 15, 2013.

(51) Int. Cl. G01L 13/02

(52) U.S. Cl. CPC G01L 13/025
USPC 73/717

(57) ABSTRACT

An example embodiment of the present invention provides a differential piezoresistive sensor assembly and method of manufacturing and using the same, such that a first and second pressure are applied from a single side there enabling easier installation in many pressure assemblies.

### CROSS-REFERENCE TO RELATED APPLICATION

This application claims priority under 35 U.S.C. 119 to U.S. Provisional Application No. 61/787,574, filed Mar. 15, 2013, which is hereby incorporated by reference in its entirety.

### TECHNICAL FIELD

The present invention relates generally to differential sensors and methods for manufacturing and using the same.

### BACKGROUND

The measurement of differential pressure is important for monitoring systems such as filters and Venturi tubes. Differential pressure is often measured using two pressure sensors configured to measure a first pressure and a second pressure, respectively, and subsequently determining the difference between their outputs. This system works well when line pressure is roughly the same as the differential pressure, but does not work as well when line pressure is substantially higher than the differential pressure as accuracy may be lost by using high pressure sensing assemblies. In these instances, a single differential pressure sensor, having a top face and a bottom face, is used, wherein a first pressure is applied at the front face and a second pressure is applied at the back face. The difference between the two pressures causes a diaphragm embedded within the sensor to deflect, and the sensing element outputs a signal indicative of this pressure difference. These differential sensors work well in many applications but in some cases, it may be cumbersome to configure a sensor wherein a first pressure is applied against a first side of the assembly and the second pressure is applied against a second side of the assembly.

It is therefore desirable to create a differential pressure sensor wherein both a first and second pressure may be applied against the same side of a sensor assembly. It is to this need that the present invention is directed.

### BRIEF DESCRIPTION OF THE DRAWINGS

FIG. 1 illustrates a prior art embodiment of a differential silicon piezoresistive pressure sensor assembly.

FIG. 2 illustrates an embodiment of a differential pressure sensor assembly in accordance with the present invention.

FIG. 3 illustrates a pressure scanner assembly that utilizes a differential pressure sensor embodiment of the present invention.

FIG. 4 illustrates a single plate within the pressure scanner assembly of FIG. 3 that utilizes a differential pressure sensor embodiment of the present invention.

### BRIEF SUMMARY

An example embodiment of the present invention is a differential sensor assembly, comprising a first substrate having a first side, a second side, a first channel, and a second channel. The embodiment may further comprise a diaphragm having a top side and a bottom side, wherein the bottom side is disposed on the second side of the first substrate. The first channel may be adapted to receive a first pressure applied against the first side of the first substrate and transport the first pressure to the bottom side of the diaphragm. The second channel may be adapted to receive a second pressure applied against the first side of the first substrate and transport the second pressure to a top side of the diaphragm. The first substrate may be a glass layer.

Another example embodiment of the present invention is a differential sensor assembly, comprising a first substrate having a first side, a second side, a first channel, and a second channel. The embodiment may further comprise a second substrate disposed on the second side of the first substrate, wherein the second substrate defines a diaphragm, having a top side and a bottom side, and a first aperture. The first channel may be adapted to receive a first pressure and transport the first pressure to the bottom side of the diaphragm. The second channel may be adapted to receive a second pressure and transport the second pressure through the first aperture such that the second pressure is applied to the top side of the diaphragm. The first pressure and the second pressure are both applied against the first side of the first substrate. The first substrate may be a glass layer and the second substrate may be a silicon wafer.

Another example embodiment of the present invention is a method for measuring a differential pressure, comprising receiving a first pressure at a first side of a first substrate, channeling the first pressure through the first substrate to a bottom side of a deflectable diaphragm defined within a second substrate disposed on the first substrate, receiving a second pressure at the first side of the first substrate, channeling the second pressure through the first substrate to a top side of the deflectable diaphragm, sensing the difference between the first pressure and the second pressure; and outputting a signal indicative of the difference between the first pressure and the second pressure. The first substrate may be a glass layer.

### DETAILED DESCRIPTION

Although many embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an,” and “the” include plural referents unless the context clearly dictates otherwise.

Also, in describing the many embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Referring now to the drawings, in which like numerals represent like elements, exemplary embodiments of the present invention are herein described. It is to be understood that the figures and descriptions of the present invention have been simplified to illustrate elements that are relevant for a clear understanding of the present invention, while eliminating, for purposes of clarity, many other elements found in typical pressure sensor assemblies and chip-package assemblies and methods of making and using the same. Those of ordinary skill in the art will recognize that other elements are desirable and/or required in order to implement the present invention. However, because such elements are well known in the art, and because they do not facilitate a better understanding of the present invention, a discussion of such elements is not provided herein.

An example embodiment of the present invention is a differential sensor assembly and method of manufacturing and using the same. In an example embodiment, a first and second pressure are applied against a single side of a sensor, which enables relatively easy installation in many pressure sensor assemblies, for example but not limited to, pressure scanner assemblies. In an example embodiment, first and second pressures are applied through first and second channels, respectively. The first and second channels are defined within a glass pedestal upon which a silicon layer, comprising a diaphragm and a sensing element, is mounted. The glass pedestal defines a first micromachined channel that routes the first pressure to a bottom side of the diaphragm and a second micromachined channel that routes the second pressure through a cavity micromachined in the silicon layer to a top side of the diaphragm. The diaphragm then deflects according to the difference between the first and second pressures and the sensing element outputs a signal indicative of the differential pressure between the first and second pressures.

Referring to FIG. 1, there is shown a prior art embodiment of a standard differential silicon piezoresistive pressure sensor assembly. As illustrated, a first pressure, P₁, is applied to a top side of a silicon diaphragm (101). A second pressure, P₂, is applied through a channel (102) defined within a glass sealed header (103), and is then routed through an aperture defined within a glass pedestal (104) that has been bonded to a deflectable diaphragm (106). The deflectable diaphragm (106) then deflects in proportion to the difference between the first and second pressures. Piezoresistive gages (105) on the deflectable diaphragm (106) measure the difference between the first and second pressures and output an electrical signal indicative of the difference in pressures. Notably, the differential pressure sensor assemblies of the prior art initially receive first and second pressures from opposite sides of the assembly.

Distinguishably, in an example embodiment of the present invention, first and second pressures are applied against the same side of the sensor assembly. The first and second pressures are subsequently routed to bottom and top sides of a diaphragm within a sensor to measure differential pressure.

Referring to FIG. 2, there is shown an example embodiment of a differential pressure sensor assembly (200) in accordance with the present invention. The sensor assembly (200) of the present invention comprises a silicon wafer (210) that defines a deflectable diaphragm (201). The deflectable diaphragm (201) has sensing elements (208) disposed thereon such that the sensing elements (208) are aligned with deflection portions of the deflectable diaphragm (201). The sensing elements (208) may be, for example but not limited to, piezoresistive gages.

A bottom surface of the silicon wafer (210) may be mounted onto a second side of a first glass layer (202), also referred to herein as a “glass pedestal.” A second glass layer (207), also referred to herein as a “glass cover,” may be attached to portions of a top surface of the silicon wafer (210) such that a cavity (206) is defined over the sensing elements (208) and a substantial portion of the top surface of the silicon wafer (210).

The first glass layer (202) defines a first channel (203) and a second channel (204). The first and second channels may be defined using micromachining etching techniques. A first pressure, P₁, is applied against a first side (211) of the first glass layer (202). The first pressure, P₁, may be routed through the first channel (203) to a bottom side of the deflectable diaphragm (201), which is substantially aligned with the first channel (203). Unlike prior art embodiments, the second pressure, P₂, is also applied against the first side (211) of the first glass layer (202). The second pressure, P₂, may be routed through the second channel (204) defined within the first glass layer (202), and subsequently through an aperture (205) defined within the silicon wafer (210) and substantially aligned with the second channel (204). From there, the second pressure, P₂, may be routed through the cavity (206) formed by the second glass layer (207) to a top side of the deflectable diaphragm (201).

The deflectable diaphragm (201) thus receives the first pressure on the bottom side and the second pressure on the top side. As one skilled in the art will appreciate, the diaphragm deflects relative to the difference between the first and second pressures. This deflection may then be measured by the piezoresistive gages of the sensing element (208). The sensing element (208) subsequently outputs a signal indicative of the difference between the first and second pressures.

Additionally, the differential pressure sensor assembly (200) may also comprise metal pads (209) that are disposed on the silicon wafer (210) away from the diaphragm (201). In prior art embodiments, metal pads are typically disposed above the diaphragm, which subjects the metal pads to the pressure media. If this media is corrosive or conductive it may effect the pads. In this example embodiment, however, the metal pads are isolated from the media. Thus, the configuration of various of the disclosed embodiments may enhance the performance of the differential pressure sensor assembly (200) in conductive media applications.

An example method for manufacturing the differential pressure sensor assembly (200) of the present invention comprises bonding a series of sensing elements (208) to a substrate (210). Etching portions of a substrate (210), for example a silicon wafer, to define a deflectable diaphragm (201) that is aligned with the sensing elements (208). In some methods, the aperture (205) defined within the silicon wafer (210) may be etched simultaneously with the deflectable diaphragm (201). In this method, the aperture (205) may be defined at the same time as the deflectable diaphragm (201) by adjusting the thickness of an oxide layer on the silicon wafer (210) such that the aperture area is etched slightly longer than the deflectable diaphragm area to ensure that the aperture is etched all the way through the silicon wafer (210) in the same time that the deflectable diaphragm (201) is formed. In other methods, the aperture (205) may be etched in a separate step.

After the diaphragm (201) and aperture (205) are defined, the bottom surface of the silicon wafer (210) may then be mounted onto the first glass layer (202), which defines the first channel (203) and the second channel (204) in a separate pre-etching process. The first glass layer (202) provides a header or pedestal assembly for the silicon wafer (210). The silicon wafer is mounted onto the first glass layer (202) such that the deflectable diaphragm (201) area aligns with the first channel (203) and the aperture (205) aligns with the second channel (204). As previously described, the first channel (203) and second channel (204) facilitate the transport of the first and second pressures, respectively, to the deflectable diaphragm (201).

The second glass layer (207) may then be mounted onto a portion of the top surface of the silicon wafer (210) such that it provides a cover assembly for the silicon wafer (210). As previously described, the second glass layer (207) is mounted onto the silicon wafer (210) such that it defines a cavity above the aperture (205) defined within the silicon wafer (210) and extends at least to the sensing element (208).

Referring to FIG. 3, there is illustrated a differential pressure sensor assembly (200) of the present invention housed in a pressure scanner assembly (301). As one skilled in the art will appreciate, in prior art pressure scanner assemblies, each differential sensor therein requires that the same reference pressure be applied to the back of each sensor. Such a design is useful when the pressures are all referenced to the same pressure, for example, atmospheric pressure, but it is not as useful when true differential pressures, such as from two opposite sides of a filter, need to be measured. The differential pressure sensor assembly (200) of the present invention therefore enables two separate and distinct pressures applied against the top of a pressure scanner assembly to be routed to the top and bottom sides of each diaphragm, respectively, of each sensor.

As illustrated, the pressure scanner assembly (301) comprises a plurality of tubulations (302) extending from the top surface of the pressure scanner assembly (301). Each tubulation (302) receives an individual pressure. These pressures are then routed through a pressure manifold (303) to individual plates (304) disposed within the pressure scanner assembly (301). In prior art pressure scanner assemblies, the sensors disposed therein are either absolute sensors to measure absolute pressure or differential sensors referenced to a single reference pressure. In the pressure scanner assembly (301) of the present invention, however, two separate and distinct pressures may be routed to the two pressure inputs defined within the glass pedestal. In this way, the differential pressure between two adjacent pressure tubulations may be accurately measured.

Referring to FIG. 4, there is shown an exemplary embodiment of a pressure plate (400) of a pressure scanner assembly (301) utilizing the differential pressure sensor assembly (200) of the present invention. As illustrated, the differential pressure sensor assembly (200) is mounted onto a pressure plate (400). The pressure plate (400) defines a first aperture (401) and a first straight channel (403) configured to receive a first pressure, which is subsequently channeled to the first channel (203) of the differential pressure sensor assembly (200). Similarly, the pressure plate (400) defines a second aperture (405) and a second angled channel (404) configured to receive a second pressure, which is subsequently channeled to the second channel (204) of the differential pressure sensor assembly (200). Additionally, the first and second apertures (401/405) may be sealed to a pressure manifold by a sealing element, for example but not limited to, o-rings, which effectively seal each individual pressure plate from other external environments. This configuration provides spacing for the sealing element and also allows these pressure plates to be used on the same pressure scanner assembly as standard sensor plates.

It will be apparent to those skilled in the art that modifications and variations may be made in the apparatus and process of the present invention without departing from the spirit or scope of the invention.

What is claimed is:

1. A differential sensor assembly, comprising:
a first substrate having a first side, a second side, a first channel, and a second channel;
a diaphragm having a top side and a bottom side, wherein the bottom side is disposed on the second side of the first substrate;
wherein the first channel is adapted to receive a first pressure applied against the first side of the first substrate and transport the first pressure to the bottom side of the diaphragm; and
wherein the second channel is adapted to receive a second pressure applied against the first side of the first substrate and transport the second pressure to a top side of the diaphragm.

2. The differential sensor assembly of claim 1, wherein the first substrate is a glass layer.

3. The differential sensor assembly of claim 1, wherein the diaphragm is defined within a second substrate, and further wherein the second substrate is a silicon wafer.

4. A differential sensor assembly, comprising:
a first substrate having a first side, a second side, a first channel, and a second channel;
a second substrate disposed on the second side of the first substrate, wherein the second substrate defines a diaphragm, having a top side and a bottom side, and a first aperture;
wherein the first channel is adapted to receive a first pressure and transport the first pressure to the bottom side of the diaphragm;
wherein the second channel is adapted to receive a second pressure and transport the second pressure through the first aperture such that the second pressure is applied to the top side of the diaphragm;
wherein the first pressure and the second pressure are both applied against the first side of the first substrate.

5. The differential sensor assembly of claim 4, wherein the first substrate is a glass layer.

6. The differential sensor assembly of claim 4, wherein the second substrate is a silicon wafer.

7. The differential sensor assembly of claim 4, further comprising a third substrate attached to at least a portion of the second substrate opposite the first substrate.

8. The differential sensor assembly of claim 7, wherein the third substrate is a glass layer.

9. The differential sensor assembly of claim 7, wherein a cavity is defined between the third substrate and the second substrate.

10. The differential sensor assembly of claim 9, wherein the cavity is defined over at least the diaphragm and the first aperture.

11. The differential sensor assembly of claim 4, wherein the first channel is aligned with the bottom side of the diaphragm.

12. The differential sensor assembly of claim 4, wherein the second channel is aligned with the first aperture.

13. The differential sensor assembly of claim 4, further comprising a plurality of sensing elements disposed on the diaphragm.

14. The differential sensor assembly of claim 13, wherein the plurality of sensing elements are piezoresistive elements.

15. The differential sensor assembly of claim 4, further comprising metal pads disposed on the second substrate.

16. A method of measuring a differential pressure, comprising:
receiving a first pressure at a first side of a first substrate;
channeling the first pressure through the first substrate to a bottom side of a deflectable diaphragm defined within a second substrate disposed on the first substrate;
receiving a second pressure at the first side of the first substrate;
channeling the second pressure through the first substrate to a top side of the deflectable diaphragm;
sensing the difference between the first pressure and the second pressure; and
outputting a signal indicative of the difference between the first pressure and the second pressure.

17. The method of claim 16, wherein the first pressure is channeled through a first channel defined in the first substrate and aligned with the bottom side of the deflectable diaphragm.

18. The method of claim 16, wherein the second pressure is channeled through a second channel defined in the first substrate and aligned with a first aperture defined within the second substrate.

19. The method of claim 16, wherein the first substrate is a glass layer.

20. The method of claim 16, wherein the second substrate is a silicon wafer.
